(19) United States
(12) Patent Application Publication
(10) Pub. No.: US 2005/0261008 A1
(43) Pub. Date: Nov. 24, 2005

(54) Radio transmission-enabled portable digital data storage device and method

(76) Inventor: Wen-Chih Lin, SanChung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/829,335

(22) Filed: Apr. 22, 2004

(51) Int. Cl. H04Q 7/20

(52) U.S. Cl. 455/466

(57) ABSTRACT

A radio transmission-enabled portable digital data storage device and method includes at least a mobile communication module, a data storage device, a pushbutton device, a simple management module (SMM) and an external connection device to transmit digital data stored in the portable data storage device through a desired data transmission means to a preset data storage area.

### FIELD OF THE INVENTION

The present invention relates to a portable digital data storage device and method and particularly to a radio transmission-enabled portable digital data storage device and method that includes at least a mobile communication module, a pushbutton device, a data storage device, a simple management module (SMM) and an external connection device.

### BACKGROUND OF THE INVENTION

With arriving of information age, information life is a trend modern people have to live with. In addition, digital technologies have become increasingly popular, more and more living-related information are digitized. As a result, a wide variety of digital information storage devices have been introduced.

Hard disk is the earliest large capacity digital data storage device. With advanced technologies, data density of hard disk increases significantly. However, hard disk generally has to be coupled to the computer. Although it has the advantage of large capacity, it also has drawbacks such as cannot be disassembled easily and has compatibility problem among different systems. These problems have been largely resolved with the introduction of portable hard disk. Adopting the plug and play operation principle, the hard disk now has overcome the single machine limitation and the compatibility problem among different systems. While the portable hard disk has large capacity, its impact-resistant mechanism is relatively weak. Hence for carrying at a long period of time and repetitive use, data safety and integrity is still a concern.

Thus at present the portable disk that combines the benefits of convenience of the portable hard disk and fast retrieval of the random access memory has become the best choice for transmitting digital data. It has a small size, can be used almost unlimited number of times, and can withstand great impacts. It is desirable for use in frequent digital data transmission and exchange. It also may be coupled with various types of electronic devices such has FM radio, MP3 player, answering machine, and the like. Hence besides data storage function, it has a wide range of applicability.

Due to increasingly popular of digital devices, the portable disk that originally has adequate capacity also encounters constraints such as cannot accommodate all of data or transmit the completed data at one pass. It frequently occurs that one portable disk has to be used for storing and retrieving data multiple of times, or multiple number of portable disks have to be used. In the event that data storing operation cannot be waited, such as during user is out or on an oversea trip, there is a risk that the single use portable disk could run out of capacity or incomplete transmission of digital data might occur. Hence there is need to provide a storage device that can easily store a large amount of digital data.

### SUMMARY OF THE INVENTION

Therefore the primary object of the invention is to provide a radio transmission-enabled portable digital data storage device and method for transmitting stored digital data to a larger data storage space through a mobile communication equipment and the Internet to enable the portable digital data storage device to continuously store other digital data.

The radio transmission-enabled portable digital data storage device according to the invention includes at least a data storage device for storing digital data, a mobile communication module for transmitting the digital data stored in the data storage device to a preset digital storage space, a pushbutton device to control digital data transmission stored in the digital storage space, an external connection device linking to a corresponding transmission hardware for transmitting and storing digital data, and a simple management module (SMM) for controlling operations of the portable digital data storage device and transmitting the stored digital data through a desired means to a preset data storage space. In addition, the invention may be coupled with a radio receiving device, a MP3 player, a digital video camera or a digital recording device to integrate functions and expand the applicability of the portable digital data storage device of the invention.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a process flowchart of an embodiment of the invention.

FIG. 2 is a block diagram of an embodiment of the invention.

FIG. 3 is a block diagram of another embodiment of the invention.

### DESCRIPTION OF THE PREFERRED EMBODIMENTS

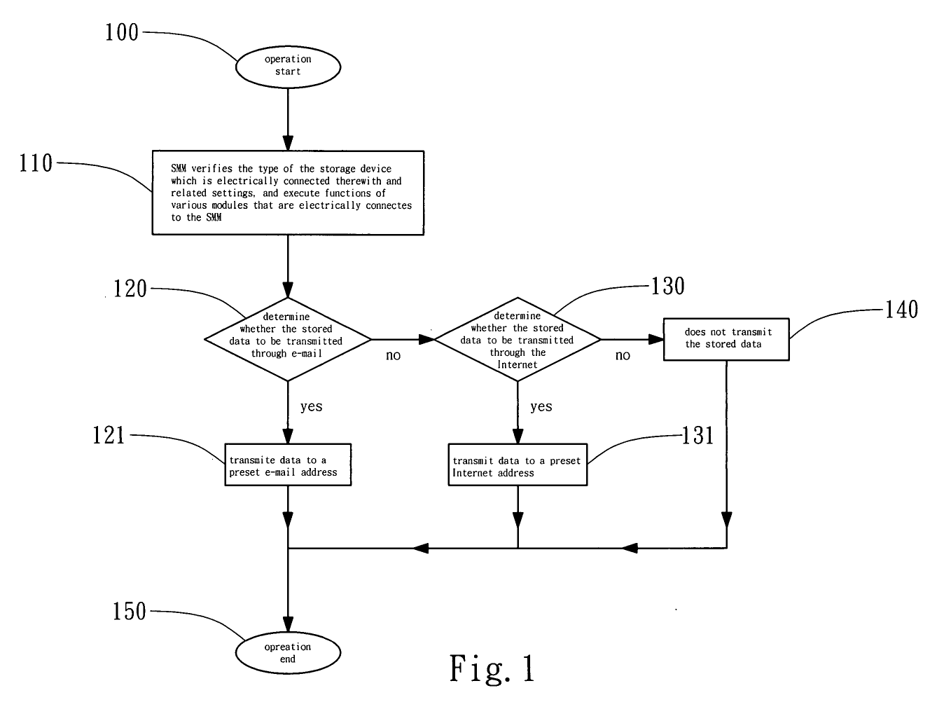

Refer to FIG. 1 for the process flowchart of an embodiment of the invention. The method for the radio transmission-enabled portable digital data storage device according to the invention includes at least the following steps:
S100 start operation;
S110 SMM verifies the type of the storage device which is electrically connected therewith and related settings, and execute functions of various modules that are electrically connected to the SMM;
S120 determine whether the stored data to be transmitted through e-mail; if positive, go to S121; if negative, go to S130;
S121 transmit data to a preset e-mail address, enter S150;
S130 determine whether the stored data to be transmitted through the Internet; if positive, go to S131; if negative, go to S140;
S131 transmit data to a preset Internet address, go to S150;
S140 does not transmit the stored data; go to S150;
S150 Operation end.

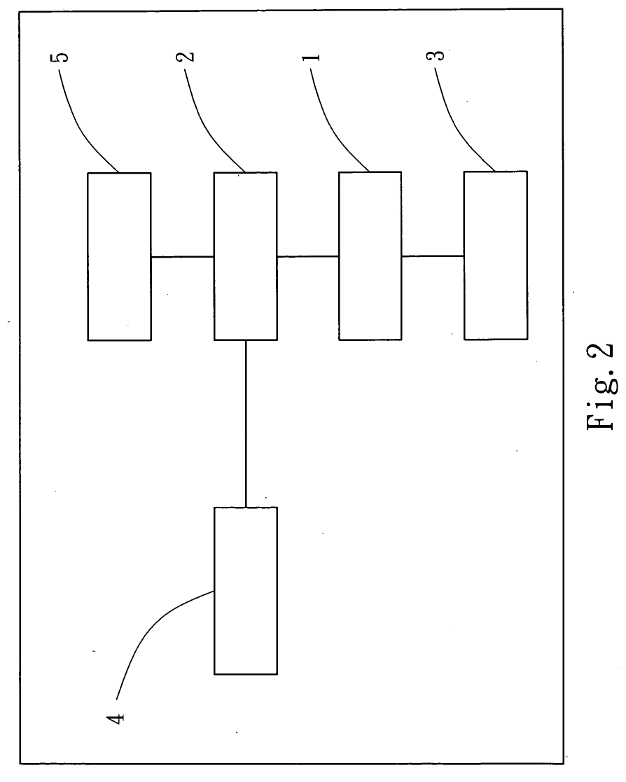

Refer to FIG. 2 for a block diagram of an embodiment of the invention. The radio transmission-enabled portable digital data storage device according to the invention includes a data storage device 1 for storing digital data, a simple management module (SMM) 2 for verifying the type of the storage device which is electrically connected therewith and related settings and executing functions of various modules that are electrically connected to the SMM 2, an external connection device 3 linking electrically to the data storage device 1 to connect an external electronic device for transmitting digital data stored in a memory device to a preset e-mail box or Internet address through a desired data transmission means, a pushbutton device 4 connected electrically to the external connection device 3 and the SMM 2 for controlling digital data transmission of the portable storage device, and a mobile communication module 5 electrically connected to the SMM 2 for transmitting the digital data stored in the data storage device 1 to the preset e-mail box or Internet address.

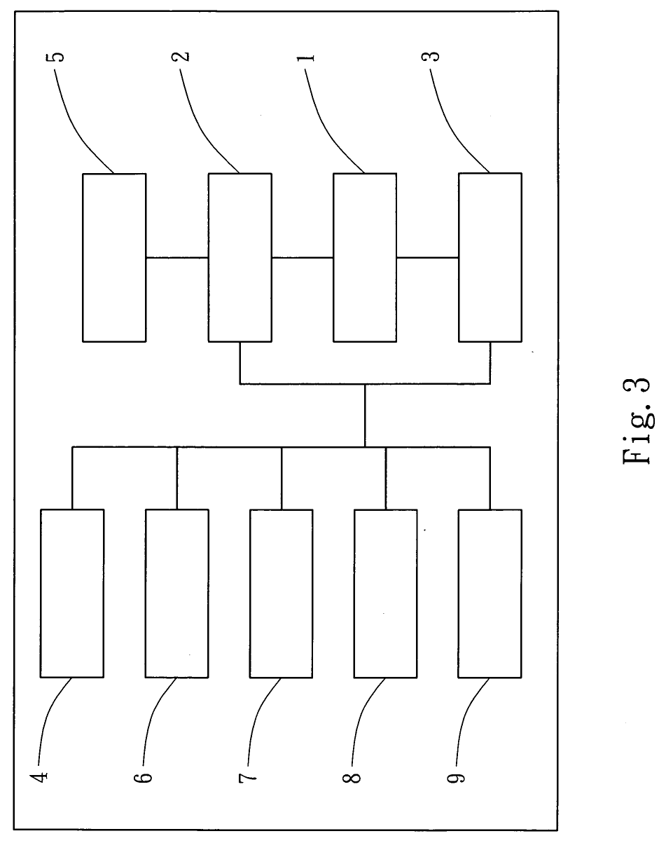

Refer to FIG. 3 for a block diagram of another embodiment of the invention. The radio transmission-enabled portable digital data storage device according to the invention includes a data storage device 1 for storing digital data, a simple management module (SMM) 2 for verifying the type of the storage device which is electrically connected therewith and related settings and executing functions of various modules that are electrically connected to the SMM, an external connection device 3 linking electrically to the data storage device 1 to connect an external electronic device for transmitting digital data stored in a memory device to a preset e-mail box or Internet address through a desired data transmission means, a pushbutton device 4 connected electrically to the external connection device 3 and the SMM 2 for controlling digital data transmission of the portable storage device, and a mobile communication module 5 electrically connected to the SMM 2 for transmitting the digital data stored in the data storage device 1 to a preset e-mail box or Internet address, a MP3 player 6 electrically connecting to the external connection device 3 and SMM2 to broadcast MP3 and compatible files, a radio receiving module 7 electrically connecting to the external connection device 3 and SMM2 to receive and broadcast radio contents, a digital video camera 8 included a digital camera lens electrically connecting to the external connection device 3 and SMM2 to take pictures and store the pictures in the data storage device 1, and an audio recording device 9 electrically connecting to the external connection device 3 and SMM2 to store external audio signals in file formats in the data storage device 1.

The data storage device 1 may be one of the followings: Synchronous Dynamic Random Access Memory (SDRAM), Double Duration Rate Random Access Memory (DDR RAM), Direct RDRAM (Direct RAM BUS DRAM) or Synchronous Link DRAM (SLDRAM). The SSM 2 may be Electrically Erasable & Programmable ROM (EEROM), Flash ROM, Erasable & Programmable ROM (EPROM), or Electrically Erasable & Programmable ROM (EEPROM). The external connection device 3 may be an IEEE-1394 interface or Universal Serial Bus (USB). The mobile communication module 5 may be a 2.5G communication module or 3G communication module. The audio recording device 9 can store the recorded external audio signals in digital file formats in the data storage device 2.

By means of the device and method described above, stored digital data may be transmitted through a mobile communication device to a preset e-mail box or a preset Internet address. Thus the device and the method of the invention provides improved functions and data transmission capability and is more convenient in operation than the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A method for a radio transmission-enabled portable digital data storage device, comprising steps of:
S100 starting operation;
S110 verifying the type and related settings of the storage device by a simple management module (SMM) that is electrically connected to the storage device, and executing functions of modules that are electrically connected to the SMM;
S120 determining whether stored data to be transmitted through e-mail; if positive, going to S121;
S121 transmitting the data to a preset e-mail address, entering S150;
S150 ending operation.

2. A radio transmission-enabled portable digital data storage device, comprising at least:
a data storage device for storing digital data;
a simple management module (SMM) for verifying the type and related settings of the storage device which is electrically connected therewith and executing functions of various modules that are electrically connected to the SMM;
an external connection device linking electrically to the data storage device to connect an external electronic device for transmitting digital data stored in a memory device to a preset e-mail box or an Internet address through a desired data transmission means;
a pushbutton device connected electrically to the SMM for controlling digital data transmission of the portable storage device; and
a mobile communication module electrically connected to the external connection device for transmitting the digital data stored in the data storage device to the preset e-mail box or the Internet address.

3. The radio transmission-enabled portable digital data storage device of claim 2, wherein the SSM is selected from the group consisting of Electrically Erasable & Programmable ROM (EEROM), Flash ROM, Erasable & Programmable ROM (EPROM), and Electrically Erasable & Programmable ROM (EEPROM).

4. The radio transmission-enabled portable digital data storage device of claim 2, wherein the data storage device is selected from the group consisting of Synchronous Dynamic Random Access Memory (SDRAM), Double Duration Rate Random Access Memory (DDR RAM), Direct RDAM (Direct RAM BUS DRAM), and Synchronous Link DRAM (SLDRAM).

5. The radio transmission-enabled portable digital data storage device of claim 2, wherein the external connection device is selectively an IEEE-1394 interface and a Universal Serial Bus (USB).

6. The radio transmission-enabled portable digital data storage device of claim 2, wherein the mobile communication module is selectively a 2.5G communication module or a 3G communication module.

7. The radio transmission-enabled portable digital data storage device of claim 2 further including a MP3 player which is electrically connected to the external connection device and the SMM to broadcast MP3 and compatible files.

8. The radio transmission-enabled portable digital data storage device of claim 2 further including a radio receiving module which is electrically connected to the external connection device and the SMM to receive and broadcast radio contents.

9. The radio transmission-enabled portable digital data storage device of claim 2 further including a digital video camera which has a digital camera lens and is electrically connected to the external connection device and the SMM to take pictures and store the pictures in the data storage device.

10. The radio transmission-enabled portable digital data storage device of claim 2 further including an audio recording device which is electrically connected to the external connection device and the SMM to store external audio signals in file formats in the data storage device.

11. The method of claim 1, wherein the following steps are executed when the outcome of the step S120 is negative:
S130 determining whether the stored data to be transmitted through the Internet; if positive, going to S131; and
S131 transmitting the data to a preset Internet address, going to S150;

12. The method of claim 11, wherein the following step is executed when the outcome of the step S130 is negative:
S140 no transmitting of the stored data; going to S150;
